(19) United States
(12) Patent Application Publication
(10) Pub. No.: US 2006/0062872 A1
(43) Pub. Date: Mar. 23, 2006

(54) Pressurized chewing gum compositions and dispensing method

(75) Inventors: Petros Gebreselassie, Piscataway, NJ (US); Navroz Boghani, Flanders, NJ (US)

Correspondence Address: HOFFMANN & BARON, LLP, 6900 JERICHO TURNPIKE, SYOSSET, NY, 11791, US

(73) Assignee: CADBURY ADAMS USA LLC

(21) Appl. No.: 11/202,716

(22) Filed: Aug. 12, 2005

Related U.S. Application Data
(60) Provisional application No. 60/612,410, filed on Sep. 23, 2004.

(51) Int. Cl. A23G 4/18

(52) U.S. Cl. 426/5

(57) ABSTRACT

The present invention is an article of manufacture which includes, but is not limited to, (i) a hollow container having an enclosed interior portion and an orifice in fluid communication with the interior portion; (ii) a flowable chewing gum composition contained within the interior portion; (iii) a valve having an open position to permit the gum composition to flow through the orifice and having a closed position to prevent the chewing gum from flowing through the orifice; and (iv) a propellant contained within the container under pressure for pressurably moving the gum composition through the orifice when the valve is in the open position.

### CROSS-REFERENCE TO RELATED APPLICATION

This invention claims the benefit of U.S. Provisional Application No. 60/612,410, filed Sep. 23, 2004, the content of which is incorporated herein by reference.

### FIELD OF THE INVENTION

The present invention relates to pressurized chewing gum compositions. More particularly, the present invention relates to flowable chewing gum compositions dispensable from a pressurized container.

### BACKGROUND OF THE INVENTION

Chewing gum is conventionally supplied in a number of hard or solid forms, such as sticks, balls, pellets, strips, wafers or ropes. Other hard or solid forms of chewing gum have also been described.

For example, U.S. Pat. No. 4,614,654 to Ream et al. described a taffy-like chewing gum. The '654 Patent describes the taffy-like chewing gum as being 5-30 wt. % chewing gum base in a carbohydrate syrup having a moisture level from 7 to 15%. The '654 Patent, however, fails to describe useful packaging or dispensers for its taffy-like chewing gum.

U.S. Pat. No. 4,526,790 to Samala described a chewing gum contained within a deformable polyethylene tube having a one-half inch orifice. The chewing gum is described as being room-temperature extrudable through the orifice by pressure exerted on the tube. The chewing gum is described as having a high water content of at least 11% and having a gel-forming material of xanthan, guar, locust bean, carageenen or pectin.

EP 0 086 769 A1 to Bobilliers describes a fluid, pasty chewing gum having 15 to 25% gum base, 40 to 60% glucose syrup, 20 to 40% powdered sugar, 0.1 to 5% glycerin, 0 to 1% flavoring, 0.2 to 0.4% lechithin, and 1 to 4% sorbitol. The chewing gum is described as being deliverable from a flexible package, such as a tube.

While the prior art has described chewing compositions deliverable from squeezable tubes, the prior art fails to describe flowable forms of chewable gum deliverable from non-deformable dispensers, such as pressurized containers.

### SUMMARY OF THE INVENTION

In one aspect of the present invention, an article of manufacture is provided. The article includes, but is not limited to, (i) a hollow container having an enclosed interior portion and an orifice in fluid communication with said interior portion; (ii) a flowable chewing gum composition contained within said interior portion; (iii) a valve having an open position to permit said gum composition to flow through said orifice and having a closed position to prevent said chewing gum from flowing through the orifice; and (iv) a propellant contained within said container under pressure for pressurably moving said gum composition through said orifice when said valve is in said open position.

The gum composition may be in various dispensable forms including a flowable liquid, a flowable gel, flowable solid, a deformable solid, a particulate, an aerosol and the like.

The propellant may include a pressurized gas, such as an inert gas, air and combinations thereof, or a pressurized liquid, such as an evaporative liquid at ambient temperature and ambient pressure. The pressurized liquid may also be a solvent capable of dissolving at least a portion of said gum composition. Also the propellant can be inside or outside a bladder separating the gum composition from propellant within the can.

The gum composition may comprise from about 30 weight percent to about 60 weight percent gum base. Further, the weight ratio of the gum composition to the propellant may be from about 1:5 to about 5:1, desirably from about 1:2 to about 2:1.

The propellant may be mixed with the gum composition, or the propellant may be physically separated from the gum composition.

In another embodiment of the present invention, the article or dispenser of the present invention may further include a flexible holder which is sealingly disposed within the interior portion of the container. The gum composition is disposed within the holder. The propellant is contained within the interior portion of the container and exterior to the holder.

In yet another embodiment of the present invention, the article or dispenser may further include a flexible bladder which is sealingly disposed within the interior portion of the container. The propellant is disposed within the bladder. The gum composition is contained within the interior portion of the container and exterior to the bladder.

### BRIEF DESCRIPTION OF THE DRAWINGS

FIG. 1 is a perspective view of a pressurized container or dispenser suitable for releasably dispensing the pressurized chewing gum compositions of the present invention.

FIG. 2 is a side elevational view of the dispenser of FIG. 1, where the gum composition and propellant are mixed together.

FIG. 3 is a partial side elevational vide of a closed valve within the dispenser of FIG. 1.

FIG. 4 is a partial side elevational vide of an open valve within the dispenser of FIG. 1.

FIG. 5A is a side elevational view of another embodiment of dispenser of FIG. 1, where the dispenser is pressurized or filled with the gum composition which is disposed inside a flexible bladder to separate the gum composition from the gas/propellant.

FIG. 5B is a side elevational view of the dispenser of FIG. 5A, where the dispenser is depressurized and the gum composition has been substantially or partially dispensed from the dispenser.

FIG. 6A is a side elevational view of another embodiment of dispenser of FIG. 1 having a pressurized bladder, which is separate from the gum composition, inside the dispenser for egress of the gum composition.

FIG. 6B is a side elevational view of the dispenser of FIG. 6A, where the dispenser is depressurized and the gum composition has been substantially or partially dispensed from the dispenser.

FIG. 7 is a graphical depiction of a viscosity curve for compositions of the present invention.

### DETAILED DESCRIPTION OF THE INVENTION

In one embodiment, the present invention is an article of manufacture having a pressurized chewing gum composition resealably contained within a pressurized dispenser. As used herein, the terms “chewing gum” and “bubble gum” are used interchangeably and are both meant to include any masticatable gum compositions.

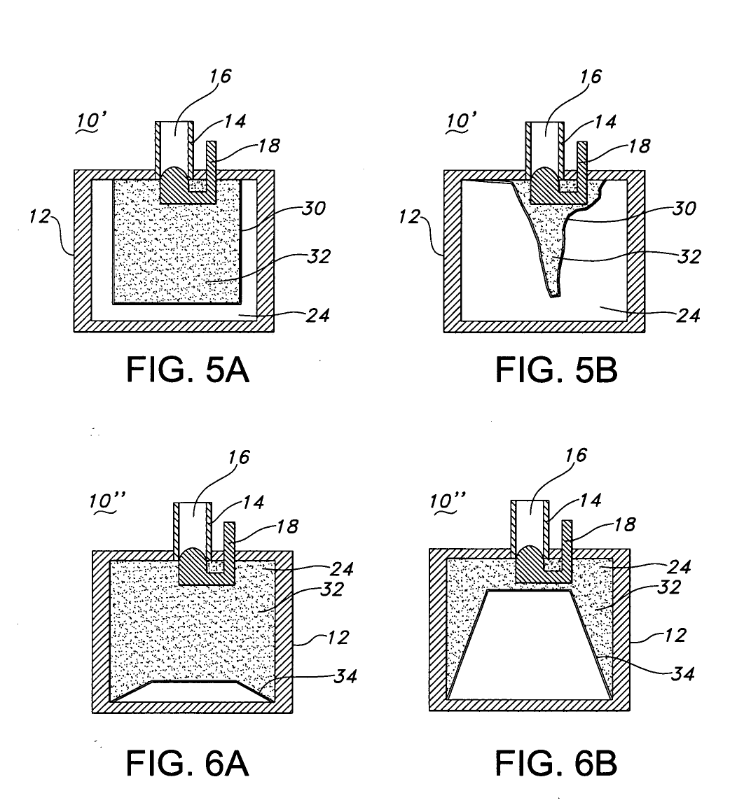

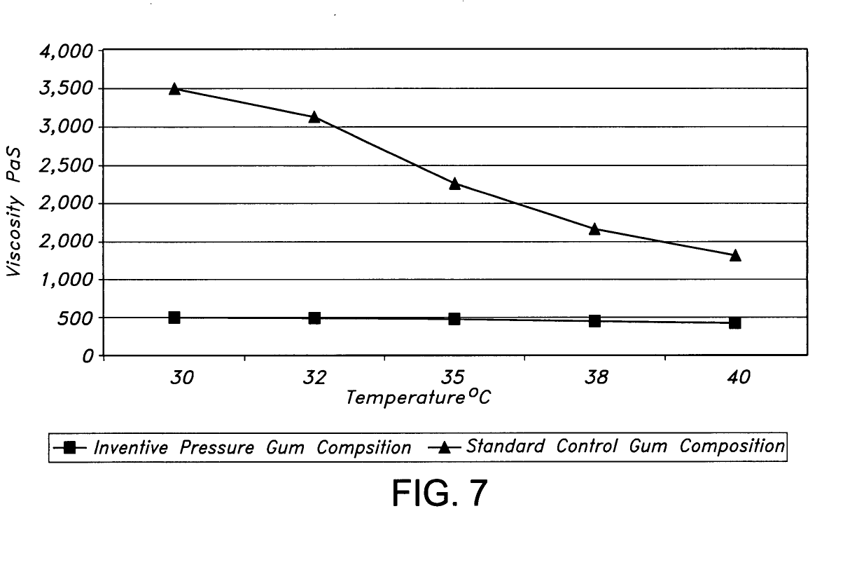

The chewing gum composition may be in any useful flowable form, for example, a liquid, a gel, a flowable or soft solid, such as a taffy-like solid, a solid or liquid particulate, and the like. As used herein, the term “liquid” refers to compositions which will readily flow or maintain fluid properties at room temperature and pressure. As used herein, the term “gel” refers to compositions which are soft and somewhat elastic. Rheologically, conventional gum compositions (pellets, sticks, chunk gums) have high viscosity to resist flowing during storage at ambient temperatures. The pressurized can gum compositions of the present invention have relatively lower viscosities such that the pressure in the can or dispenser results in smooth flowing of the gum out of the dispenser. FIG. 5 shows viscosity comparison curves of conventional gum compositions versus pressurized can gum compositions of the present invention. A useful, but not limiting, viscosity range for flowing gum composition of the present invention is from about 100 PaS to about 1,500 PaS.

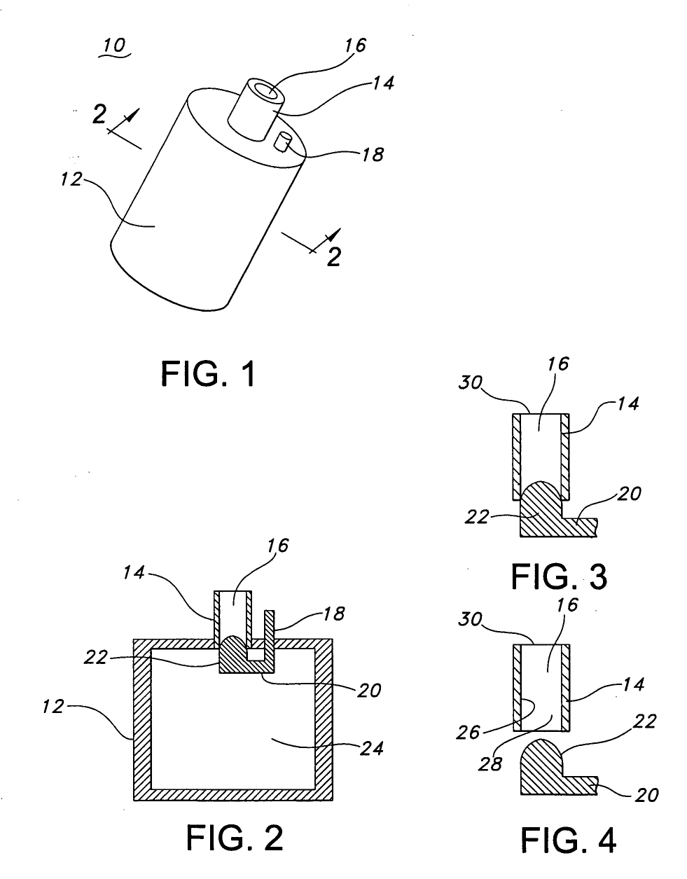

Now referring to the figures, wherein like elements are identically or similarly numbered, the compositions of the present invention are releasably contained within a pressurized dispenser or container 10. The dispenser 10 is depicted in a perspective view in FIG. 1 and is depicted in a cross-sectional view in FIG. 2 taken along the 2-2 axis. The pressure within the dispenser 10 may vary from about 10 pounds pre square inch gauge (psig) to about 100 psig. These pressures are, however, nonlimiting and other pressures may suitably be used.

Dispenser 10 is depicted as a generally cylindrical container, but other shapes may suitably be used. The dispenser 10 includes a dispenser wall 12, a nozzle 14 having an orifice 16 therethrough, and a valve actuator 18, interrelated as shown in FIG. 1. While the orifice 16 is depicted as a generally cylindrical member, the present invention is not so limited and other shaped orifices, such as oval, square, star, and the like, may suitably be used. The dispenser 10 has in hollow interior portion 24 for containing the pressurized chewing gum compositions (not shown) of the present invention. The orifice 16 is in fluid communication with the interior portion 24 of the dispenser 10. Valve 22 sealingly engages the interior portions 26 and/or nozzle entrance 28 of the nozzle 14 to close the orifice 16 from the interior portion 24 of the dispenser 10. As depicted in FIG. 3, in a closed position valve 22 prevents the exit of the chewing gum compositions (not shown) and the propellant (not shown), such as pressurized inert gas, from escaping from the interior portion 24 through the orifice exit 30. As depicted in FIG. 4, in an open position valve 22 no longer engages the interior portions 26 and/or nozzle entrance 28 of the nozzle 14, thereby allowing fluid communication from the interior portion 24 of the dispenser 10 through the orifice 16, including nozzle exit 30.

Valve 22 is connected to valve actuator 18 via member 20. When valve actuator 18 is depressed or otherwise moved toward the interior portion 24 of the dispenser 10, member 20 transfers this mechanical movement into movement of the valve 22 from the closed position to the open position. When depression force is released from the valve actuator 18, valve 22 returns to its closed position and the valve actuator 18 returns to its quiescent position. A bias, such as a spring (not shown), may be placed around the valve actuator 18 and within the interior portion 24 of the dispenser for resiliently returning the valve actuator 18 to its quiescent position, thereby and correspondingly returning the valve 22 to its closed position. Alternatively, the pressurized compositions themselves may act as a bias to close the valve 22 when the valve actuator 18 is not being depressed.

The configuration of the dispenser 10 as depicted in FIGS. 1-4 is not, however limiting, and other configurations may suitably be used. Moreover, the configuration of the valve 22 and the valve actuator 18 as depicted in FIGS. 1-4 are not limiting and other suitable configurations may suitably be used. Additional details of pressurized containers with valve sealing may be found in U.S. Pat. No. 4,120,431 to Schultz, the contents of which are incorporated herein by reference.

FIGS. 5A-5B are side elevation views of an additional embodiment of the dispenser 10′ of the present invention. The chewing gum composition 32 of the present invention is disposed within a flexible holder 30. The flexible holder 30 may be of any suitable shape, for example, a tube, a bladder or the like. The flexible holder may be of any suitable material that is flexible and forms a barrier between the chewing gum composition 32 and the propellant to separate the chewing gum composition 32 from the propellant. The barrier may be substantially fluid tight. A suitable, but nonlimiting, material for the holder 30 may be a polymeric plastic or rubber. The propellant (not shown) is disposed within the interior portion 24 of the dispenser 10′ and exterior to the holder 30. As depicted in FIG. 5A, the chewing gum composition 32 is sealing disposed within the holder 30 when the valve 22 is in the closed position. When the valve 22 is opened (not shown), the propellant compresses or collapses the holder 30 and the chewing gum composition 32 contained therein, thereby forcing the chewing gum composition 32 from the holder 30 through the nozzle 14. As depicted in FIG. 5B, the chewing gum composition 32 is substantially or partially dispensed from the holder 30 and the container 10′. The holder 30 is depicted in an expanded or quiescent state in FIG. 5A, thereby depicting the holder 30 being filled or substantially filled with the chewing gum composition 32. The holder 30 is depicted in a collapsed state in FIG. 5B, thereby depicting substantial or partial egress of the chewing gum composition from the container 10′.

FIGS. 6A-6B are side elevation views of yet another embodiment of the dispenser 10″ of the present invention. The propellant (not shown) is disposed within a flexible bladder 34. The flexible bladder 34 may be of any suitable shape, for example, a tube, a bladder, a cone and the like. The flexible bladder 34 may be of any suitable material that is flexible and forms a barrier between the chewing gum composition 32 and the propellant to separate the chewing gum composition 32 from the propellant. The barrier may be substantially fluid tight. A suitable, but nonlimiting, material for the bladder 34 may be a polymeric plastic or a rubber. The chewing gum composition 32 is disposed within the interior portion 24 of the dispenser 10″ and exterior to the bladder 34. As depicted in FIG. 6A, the chewing gum composition 32 is sealing disposed within the container 10″ when the valve 22 is in the closed position. When the valve 22 is opened (not shown), the propellant expands the bladder 34 against the chewing gum composition 32, thereby forcing the chewing gum composition 32 from the interior portion 24 of the dispenser 10″ through the nozzle 14. As depicted in FIG. 6B, the chewing gum composition 32 is substantially (or partially) dispensed from the container 10″. The bladder 32 is depicted in a contracted or quiescent state in FIG. 5A, thereby depicting the interior portion 24 of the container 10″ being filled or substantially filled with the chewing gum composition 32. The bladder 34 is depicted in an expanded state in FIG. 6B, thereby depicting substantial or partial egress of the chewing gum composition from the container 10″.

The gum composition may include any component known in the chewing gum art. For example, the gum composition may include elastomers, bulking agents, waxes, elastomer solvents, emulsifiers, plasticizers, fillers and mixtures thereof, provided that the composition is flowable through an orifice under reasonable pressures.

The gum composition may also include a specific polyol composition. The polyol composition may include any polyol known in the art including, but not limited to maltitol, sorbitol, erythritol, xylitol, mannitol, isomalt, lactitol and combinations thereof. Lycasin which is a hydrogenated starch hydrolysate including sorbitol and maltitol, may also be used.

Maltitol is a sweet, water-soluble sugar alcohol useful as a bulking agent in the preparation of beverages and foodstuffs and is more fully described in U.S. Pat. No. 3,708,396, which disclosure is incorporated herein by reference. Maltitol is made by hydrogenation of maltose which is the most common reducing disaccharide and is found in starch and other natural products.

The polyol composition which may include one or more different polyols which may be derived from a genetically modified organism (“GMO”) or GMO free source. For example, the maltitol may be GMO free maltitol or provided by a hydrogenated starch hydrolysate. For the purposes of this invention, the term “GMO-free” refers to a composition that has been derived from process in which genetically modified organisms are not utilized.

The elastomers (rubbers) employed in the gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

The amount of elastomer employed in the gum base may vary depending upon various factors such as the type of gum base used, the consistency of the gum composition desired and the other components used in the composition to make the final chewing gum product.

In some embodiments, the gum base may include wax. It softens the polymeric elastomer mixture and improves the elasticity of the gum base. When present, the waxes employed will have a melting point below about 60° C., and preferably between about 45° C. and about 55° C. The low melting wax may be a paraffin wax.

In addition to the low melting point waxes, waxes having a higher melting point may be used in the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof.

The gum base may also include emulsifiers which aid in dispersing the immiscible components into a single stable system. The emulsifiers useful in this invention include glyceryl monostearate, lecithin, fatty acid monoglycerides, diglycerides, propylene glycol monostearate, and the like, and mixtures thereof.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base.

Plasticizers also include are the hydrogenated vegetable oils and include soybean oil and cottonseed oil which may be employed alone or in combination. These plasticizers provide the gum base with good texture and soft chew characteristics.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar.

In some embodiments, the gum base of this invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts.

A variety of traditional ingredients may be optionally included in the gum base in effective amounts such as coloring agents, antioxidants, preservatives, flavoring agents, and the like. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, and mixtures thereof, may also be included. Other conventional chewing gum additives known to one having ordinary skill in the chewing gum art may also be used in the gum base.

The gum composition may include amounts of conventional additives selected from the group consisting of sweetening agents (sweeteners), plasticizers, softeners, emulsifiers, waxes, fillers, bulking agents (carriers, extenders, bulk sweeteners), mineral adjuvants, flavoring agents (flavors, flavorings), coloring agents (colorants, colorings), antioxidants, acidulants, thickeners, medicaments, and the like, and mixtures thereof. Some of these additives may serve more than one purpose. For example, in sugarless gum compositions, a sweetener, such as maltitol or other sugar alcohol, may also function as a bulking agent.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glyceryl monostearate, thickeners, used alone or in combination with other softeners, such as methyl cellulose, alginates, carrageenan, xanthan gum, gelatin, carob, tragacanth, locust bean gum, pectin, alginates, galactomannans such as guar gum, carob bean gum, glucomannan, gelatin, starch, starch derivatives, dextrins and cellulose derivatives such as carboxy methyl cellulose, acidulants such as malic acid, adipic acid, citric acid, tartaric acid, fumaric acid, and mixtures thereof, and fillers, such as those discussed above under the category of mineral adjuvants.

In some embodiments, the gum region may also contain a bulking agent. Suitable bulking agents may be water-soluble and include sweetening agents selected from, but not limited to, monosaccharides, disaccharides, polysaccharides, sugar alcohols, and mixtures thereof; randomly bonded glucose polymers such as those polymers distributed under the tradename POLYDEXTROSE by Pfizer, Inc., Groton, Conn.; isomalt (a racemic mixture of alpha-D-glucopyranosyl-1,6-mannitol and alpha-D-glucopyranosyl-1,6-sorbitol manufactured under the tradename PALATINIT by Suddeutsche Zucker), maltodextrins; hydrogenated starch hydrolysates; hydrogenated hexoses; hydrogenated disaccharides; minerals, such as calcium carbonate, talc, titanium dioxide, dicalcium phosphate; celluloses; and mixtures thereof.

Suitable sugar bulking agents include monosaccharides, disaccharides and polysaccharides such as xylose, ribulose, glucose (dextrose), mannose, galactose, fructose (levulose), sucrose (sugar), maltose, invert sugar, partially hydrolyzed starch and corn syrup solids, and mixtures thereof.

Suitable sugar alcohol bulking agents include sorbitol, xylitol, mannitol, galactitol, maltitol, and mixtures thereof. 100541 Suitable hydrogenated starch hydrolysates include those disclosed in U.S. Pat. Nos. 25,959, 3,356,811, 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN, a commercially available product manufactured by Roquette Freres of France, and HYSTAR, a commercially available product manufactured by Lonza, Inc., of Fairlawn, N.J., are also useful.

The sweetening agents used may be selected from a wide range of materials including water-soluble sweeteners, water-soluble artificial sweeteners, water-soluble sweeteners derived from naturally occurring water-soluble sweeteners, dipeptide based sweeteners, and protein based sweeteners, including mixtures thereof. Without being limited to particular sweeteners, representative categories and examples include:

(a) water-soluble sweetening agents such as dihydrochalcones, monellin, steviosides, glycyrrhizin, dihydroflavenol, and sugar alcohols such as sorbitol, mannitol, maltitol, and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructofuranoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro 4,6,1′,6′-tetradeoxygalacto-sucrose; and 4,6,1′,6′-tetradeoxy-sucrose, and mixtures thereof; and

(e) protein based sweeteners such as thaumaoccous danielli (Thaumatin I and II).

Desirably, the sweetener is a high intensity sweetener such as aspartame (APM), sucralose, and acesulfame potassium (Ace-K).

In general, an effective amount of sweetener may be utilized to provide the level of sweetness desired, and this amount may vary with the sweetener selected.

The flavoring agents which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, and fruit essences including apple, pear, peach, grape, strawberry, raspberry, cherry, plum, pineapple, apricot and so forth. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below.

Other useful flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. This may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, the flavoring agent may be employed in either liquid form and/or dried form. When employed in the latter form, suitable drying means such as spray drying the oil may be used. Alternatively, the flavoring agent may be absorbed onto water soluble materials, such as cellulose, starch, sugar, maltodextrin, gum arabic and so forth or may be encapsulated. The actual techniques for preparing such dried forms are well-known.

In some embodiments, the flavoring agents may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

The amount of flavoring agent employed herein may be a matter of preference subject to such factors as the type of final chewing gum composition, the individual flavor, the gum base employed, and the strength of flavor desired. Thus, the amount of flavoring may be varied in order to obtain the result desired in the final product and such variations are within the capabilities of those skilled in the art without the need for undue experimentation. In gum compositions, the flavoring agent is generally present in amounts from about 0.02% to about 5%, and more specifically from about 0.1% to about 2%, and even more specifically, from about 0.8% to about 1.8%, by weight of the chewing gum composition.

Coloring agents may be used in amounts effective to produce the desired color. The coloring agents may include pigments which may be incorporated in amounts up to about 6%, by weight of the gum composition. For example, titanium dioxide may be incorporated in amounts up to about 2%, and preferably less than about 1%, by weight of the gum composition. The colorants may also include natural food colors and dyes suitable for food, drug and cosmetic applications. These colorants are known as FD&C dyes and lakes. The materials acceptable for the foregoing uses are preferably water-soluble. Illustrative nonlimiting examples include the indigoid dye known as FD&C Blue No. 2, which is the disodium salt of 5,5-indigotindisulfonic acid. Similarly, the dye known as FD&C Green No. 1 comprises a triphenylmethane dye and is the monosodium salt of 4-[4-(N-ethyl-p-sulfoniumbenzylamino) diphenylmethylene]-[1-(N-ethyl-N-p-sulfoniumbenzyl)-delta-2,5-cyclohexadieneimine]. A full recitation of all FD&C colorants and their corresponding chemical structures may be found in the Kirk-Othmer Encyclopedia of Chemical Technology, 3rd Edition, in volume 5 at pages 857-884, which text is incorporated herein by reference.

Suitable oils and fats usable in gum compositions include partially hydrogenated vegetable or animal fats, such as coconut oil, palm kernel oil, beef tallow, and lard, among others. These ingredients when used are generally present in amounts up to about 7%, and preferably up to about 3.5%, by weight of the gum composition.

Additional Components

Additional additives, such as physiological cooling agents, throat-soothing agents, spices, warming agents, tooth-whitening agents, breath-freshening agents, vitamins minerals, caffeine, drugs and other actives may also be included in any or all portions or regions of the chewing gum composition. Such components may be used in amounts sufficient to achieve their intended effects.

With respect to cooling agents, a variety of well known cooling agents may be employed. For example, among the useful cooling agents are included menthol, xylitol, menthane, menthone, ketals, menthone ketals, menthone glycerol ketals, substituted p-menthanes, acyclic carboxamides, substituted cyclohexanamides, substituted cyclohaxane carboxamides, substituted ureas and sulfonamides, substituted menthanols, hydroxymethyl and hydroxymethyl derivatives of p-menthane, 2-mercapto-cyclo-decanone, 2-isoprpanyl-5-methylcyclohexanol, hydroxycarboxylic acids with 2-6 carbon atoms, cyclohexanamides, menthyl acetate, menthyl lactate, menthyl salicylate, N,2,3-trimethyl-2-isopropyl butanamide (WS-23), N-ethyl-p-menthane-3-carboxamide (WS-3), menthyl succinate, 3,1-menthoxypropane 1,2-diol, among others. These and other suitable cooling agents are further described in the following U.S. patents, all of which are incorporated in their entirety by reference hereto: U.S. Pat. Nos. 4,230,688 and 4,032,661 to Rowsell et al.; U.S. Pat. No. 4,459,425 to Amano et al.; U.S. Pat. No. 4,136,163 to Watson et al.; U.S. Pat. No. 5,266,592 to Grub et al.; and U.S. Pat. No. 6,627,233 to Wolf et al. These cooling agents may be present in one or more of the outer gum coatings, the gum region surrounding the liquid fill, the liquid fill per se, or in any combination of those three gum areas. Cooling agents, when used in the outer coating composition for the gum, are generally present in amount of 0.01% to about 1.0%. When used in the other portions of the gum, such as the gum region or the center fill, they may be present in amounts of about 0.001 to about 10% by weight of the total chewing gum piece.

Warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethyleather, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

The sensation of warming or cooling effects may be prolonged with the use of a hydrophobic sweetener as described in U.S. patent application Publication 2003/0072842 A1 to Johnson et al. which is incorporated in its entirety herein by reference. For example, such hydrophobic sweeteners include those of the formulae I-XI referenced therein. Perillartine may also be added as described in U.S. Pat. No. 6,159,509 also incorporated in its entirety herein by reference.

The breath freshening agents may include in addition to the flavors and cooling agents described hereinabove, a variety of compositions with odor controlling properties. These may include, without limitation, cyclodextrin and magnolia bark extract. The breath freshening agents may further be encapsulated to provide a prolonged breath freshening effect. Examples of malodor-controlling compositions are included in U.S. Pat. No. 5,300,305 to Stapler et al. and in U.S. patent application Publication Nos. 2003/0215417 and 2004/0081713 which are incorporated in their entirety herein by reference

As described above, a variety of oral care products may also be included in some embodiments of chewing gums. These may include tooth whiteners, stain removers and anticalculus agents. Examples of these include, but are not limited to hydrolytic agents including proteolytic enzymes, abrasives such as hydrated silica, calcium carbonate, sodium bicarbonate and alumina, other active stain-removing components such as surface-active agents, such as anionic surfactants such as sodium stearate, sodium palminate, sulfated butyl oleate, sodium oleate, salta of fumaric acid, glycerol, hydroxylated lecithin, sodium lauryl sulfate and chelators such as polyphosphates, which are typically employed in dentifrice compositions as tartar control ingredients. Also included are tetrasodium pyrophosphate and sodium tri-polyphosphate, sodium tripolyphosphate, xylitol, hexametaphosphate, and an abrasive silica. Further examples are included in the following U.S. Patents which are incorporated in their entirety herein by reference: U.S. Pat. No. 5,227,154 to Reynolds, U.S. Pat. No. 5,378,131 to Greenberg and U.S. Pat. No. 6,685,916 to Holme et al.

A variety of drugs, including medications, herbs, and nutritional supplements may also be included in the gum formulations. Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra®, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Examples of active ingredients contemplated for use in the present invention include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

Analgesics include opiates and opiate derivatives, such as Oxycontin, ibuprofen, aspirin, acetaminophen, and combinations thereof that may optionally include caffeine.

Other drug ingredients for use in embodiments include anti-diarrheals such as immodium AD, anti-histamines, anti-tussives, decongestants, vitamins, and breath fresheners. Also contemplated for use herein are anxiolytics such as Xanax; anti-psychotics such as clozaril and Haldol; non-steroidal anti-inflammatories (NSAID's) such as ibuprofen, naproxen sodium, Voltaren and Lodine, anti-histamines such as Claritin, Hismanal, Relafen, and Tavist; anti-emetics such as Kytril and Cesamet; bronchodilators such as Bentolin, Proventil; anti-depressants such as Prozac, Zoloft, and Paxil; anti-migraines such as Imigra, ACE-inhibitors such as Vasotec, Capoten and Zestril; anti-Alzheimer's agents, such as Nicergoline; and CaH-antagonists such as Procardia, Adalat, and Calan.

The popular H2-antagonists which are contemplated for use in the present invention include cimetidine, ranitidine hydrochloride, famotidine, nizatidien, ebrotidine, mifentidine, roxatidine, pisatidine and aceroxatidine.

Active antacid ingredients include, but are not limited to, the following: aluminum hydroxide, dihydroxyaluminum aminoacetate, aminoacetic acid, aluminum phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminum mono-ordibasic calcium phosphate, tricalcium phosphate, potassium bicarbonate, sodium tartrate, sodium bicarbonate, magnesium aluminosilicates, tartaric acids and salts.

A variety of other nutritional supplements may also be included in the gum compositions. Virtually any vitamin or mineral may be included. For example, vitamin A, vitamin C, vitamin D, vitamin E, vitamin K, vitamin B₆, vitamin B₁₂, thiamine, riboflavin, biotin, folic acid, niacin, pantothenic acid, sodium, potassium, calcium, magnesium, phosphorus, sulfur, chlorine, iron, copper, iodine, zinc, selenium, manganese, chromium, molybdenum, fluorine, cobalt and combinations thereof, may be used.

Examples of nutritional supplements are set forth in U.S. patent application Publication Nos. 2003/0157213 A1, 2003/0206993 and 2003/0099741 A1 which is incorporated in their entirety herein by reference.

Various herbs may also be included such as those with various medicinal or dietary supplement properties. Herbs are generally aromatic plants or plant parts that can be used medicinally or for flavoring. Suitable herbs can be used singly or in various mixtures. Commonly used herbs include Echinacea, Goldenseal, Calendula, Aloe, Blood Root, Grapefruit Seed Extract, Black Cohosh, Cranberry, Ginko Biloba, St. John's Wort, Evening Primrose Oil, Yohimbe Bark, Green Tea, Maca, Bilberry, Lutein, and combinations thereof.

The features and advantages of the present invention are more fully shown by the following examples which are provided for purposes of illustration, and are not to be construed as limiting the invention in any way.

### EXAMPLES

Conventional and pressurized chewing gum compositions are prepared with ingredients as shown below in Table 1. All the four compositions are placed within a flexible polymer tube or holder which is placed in a metal container. The metal container is pressurized with a gas. The pressurized chewing gum compositions, i.e., A(2) and B(2), easily flow from the container whereas the conventional gum compositions, i.e., A(1) and B(1), do not flow.

TABLE 1
Inventive Pressurized, Flowable Chewing Gum Compositions
Compared Against Control Chewing Gum Compositions

| | Chewing Gum Compositions | | | |
|---|---|---|---|---|
| | A (Sugar gum) | | B (Sugarless gum) | |
| | Wt. % | | Wt. % | |
| Ingredients: | (1) | (2) | (1) | (2) |
| Gum Base | 30 | 30 | 32 | 32 |
| Pulverized Sugar⁽³⁾ | QS | QS | — | — |
| Corn Syrup | 20 | 53 | — | — |
| Sorbitol⁽³⁾ | — | — | QS | QS |
| Lycasin | — | — | — | 30 |
| Glycerin | 2 | 4 | 2 | 4 |
| Flavors | 2 | 2 | 3 | 3 |
| Acesulfame potassium | — | — | 0.15 | 0.15 |
| Aspartame | — | — | 0.45 | 0.45 |
| Total | 100 | 100 | 100 | 100 |

Notes:
(1) Conventional Chewing Gum Composition.
(2) Inventive Pressurized Gum Compositions.
⁽³⁾Q.S.: abbr. Lat. Quantum Sufficit (as much as suffices)

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

What is claimed is:

1. An article of manufacture comprising:
a hollow container having an enclosed interior portion and an orifice in fluid communication with said interior portion;
a flowable chewing gum composition contained within said interior portion;
a valve having an open position to permit said gum composition to flow through said orifice and having a closed position to prevent said chewing gum from flowing through the orifice; and
a propellant contained within said container under pressure for pressurably moving said gum composition through said orifice when said valve is in said open position.

2. The article of claim 1, wherein said gum composition is a flowable liquid.

3. The article of claim 1, wherein said gum composition is a flowable gel.

4. The composition of claim 1, wherein said gum composition is a flowable solid.

5. The composition of claim 1, wherein said gum composition is a deformable solid.

6. The article of claim 1, wherein said gum composition is a particulate.

7. The article of claim 1, wherein said chewing gum composition is an aerosol.

8. The article of claim 1, wherein said propellant comprises a pressurized gas.

9. The article of claim 1, wherein said pressurized gas is selected from the group consisting of an inert gas, air and combinations thereof.

10. The article of claim 1, wherein said propellant comprises a pressurized liquid.

11. The article of claim 10, wherein said pressurized liquid is an evaporative liquid at ambient temperature and ambient pressure.

12. The article of claim 10, wherein said pressurized liquid is a solvent capable of dissolving at least a portion of said gum composition.

13. The article of claim 1, wherein said gum composition comprises from about 30 weight percent to about 60 weight percent gum base.

14. The article of claim 1, wherein the weight ratio of gum composition to propellant is from about 1:5 to about 5:1.

15. The article of claim 1, wherein the weight ratio of gum composition to propellant is from about 1:2 to about 2:1.

16. The article of claim 1, wherein said gum composition has a viscosity from about 100 PaS to about 1,500 PaS.

17. The article of claim 1, wherein said propellant is mixed with said gum composition.

18. The article of claim 1, wherein said propellant is physically separated from said gum composition.

19. The article of claim 1, further comprising a flexible holder sealingly disposed within said interior portion of said container, wherein said gum composition is disposed within said holder and said propellant is contained within said interior portion of said container and exterior to said holder.

20. The article of claim 1, further comprising a flexible bladder sealingly disposed within said interior portion of said container, wherein said propellant is disposed within said bladder and said gum composition is contained within said interior portion of said container and exterior to said bladder.
